(19) United States
(12) Patent Application Publication
(10) Pub. No.: US 2008/0106103 A1
(43) Pub. Date: May 8, 2008

(54) Road surface generator or "RSG" device

(76) Inventor: Willie Adam Owens, Palmdale, CA (US)

Correspondence Address: Mr. WILLIE A. OWENS, 37411 LITCHFIELD ST, PALMDALE, CA, 93550, US

(21) Appl. No.: 11/517,607

(22) Filed: Nov. 8, 2006

(51) Int. Cl. H02K 7/18

(52) U.S. Cl. 290/1 R; 290/52

(57) ABSTRACT

The Road Surface Generator device is a revolutionary new device that incorporates current technology by utilizing the motion and weight of vehicles to produce clean, economical and ecologically sound electrical current. The Road Surface generator relies on kinetic energy produced by moving vehicles then transferred via a simple device located on surfaces that connect to a turbine generator to produce energy. The scope of this Device has applications that are local, national and international. Governmental and private entities can benefit by generating needed funds from its use. The Road Surface Generator is a simple device that can be produced quickly and inexpensively. It creates a reliable, study source of energy capable of furnishing energy for intersections, homes, businesses and entire communities. It would create an entirely new job market for those unemployed looking to work in the field of electrical maintenance and service.

This is an alternative energy device that utilizes the pressure created by the weight of vehicles when they contact road surfaces. This “WEIGHT” compresses either “gears” or filled “tubes or bladders”. The gears engage mechanical levers that push sprockets on a turbine causing it to rotate and produce clean electrical energy. The tubes or bladders are filled with gas, fluid that when compressed push a lever that engages sprockets on a turbine causing it to rotate and produce clean electrical energy. Pressure from the gears or filled tubes activate pistons that contact and rotate to the generator shaft. The rotating generator shaft produces clean energy. The energy produced is either used directly or stored for future use. Both rely on the principles of kinetic energy, the use of motion to produce a reliable source of clean electrical energy.

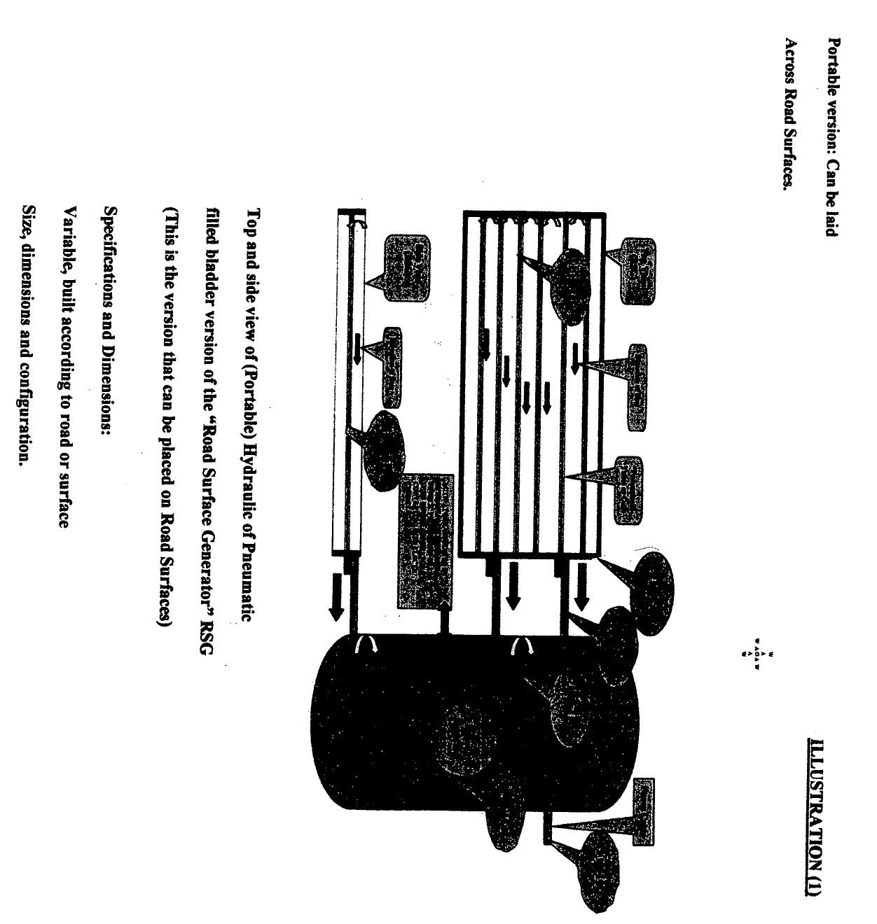

Illustration (1) is the version designed to be either portable or stationary. (FIGS. 1B to 1G) Pg ______

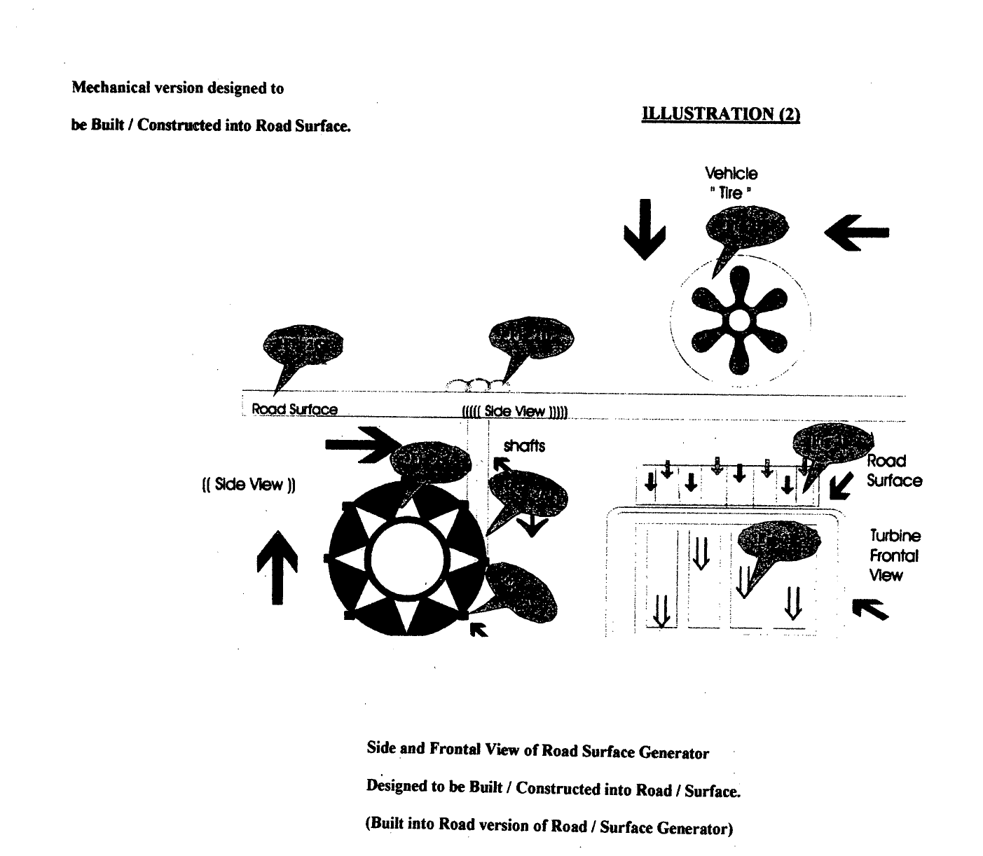

Illustration (2) is the version designed to be constructed into a road surface. (FIGS. 2A to 2H) Pg ______

The Road Surface Generator (RSG) is a low cost, efficient, reliable and viable source of low-cost electrical energy production. It is a commercially and privately viable solution for additional energy and revenue for all levels and types of governmental entities. This devise is a future marvel when combined worldwide, will exceed all present forms of electrical generation. It accomplishes this feat by utilizing simple common sense solution to resolve a complex modern day energy problem. It is a future marvel that derives astronomical benefits in the form of reliable clean energy along with a reliable source of much needed additional revenue for governmental, agencies from energy produced by overcrowded roadways and other vehicle surfaces.

This Statement Contains No New Matter (37 CFR 1.125 (b)).

### GENERAL DESCRIPTION OF SEVERAL VIEWS

Brief Description of Illustration (1):

Illustration (1) FIGS. 1A to 1G depicts the portable version of the Road Surface Generator Device. It demonstrates the flexibility of a portable alternative energy producing device. Displayed are the simple components along with their functions and operational effects. It shows a transparent Road Surface Device, its inner gas or fluid filled coils or bladder. This illustration also demonstrates how the coils or bladder will activate and rotate the generator turbine. The turbine will rotate after being compressed by the pressure of the vehicle as it passes across the road surface.

### DESCRIPTION OF SEVERAL VIEWS

Description of Illustration (2)

Illustration (2) FIGS. 2A to 2H demonstrate the feasibility of the built into the surface Road Surface Generator. This version can be built into the actual surface of the road. It is ideal for new road construction or road retrofitting. It can be used on bridges, highways, local roads and other vehicle type surfaces. The illustration shows the symmetry of all components. It displays the generator shaft along with its sprockets as well all connecting shafts and pistons. The direction of flow is indicated along with a depiction of a actual road surface and vehicle tire interaction. The illustration portrays a side view and a frontal view. The side view described above. The frontal view is an exposed view of the inter-workings of the turbine, shaft and surface piston interaction.

### ILLUSTRATION (1)

FIG. 1A:

Raised frontal view of transparent portable Road Surface Device. Displaying inner core composed of tubes or bladder filled with gas or fluid.

FIG. 1B:

Core inner tubes or bladder, displaying direction, manner and method of flow.

FIG. 1C:

Hoses leading from Road Surface Generator connecting to shaft, pistons (ACTIVATORS) that contact and move generator shaft producing clean electrical current.

FIG. 1D:

Flat, side view of transparent Road Surface Generator. Displaying inner tubes or bladder filled with air or fluid.

FIG. 1E:

Shaft or piston activators view. Engages generator shaft to produce clean energy.

FIG. 1F:

Power cable existing generator leading to electrical device or storage unit.

FIG. 1G:

Incased power generator view. Produces efficient, clean and reliable electrical energy.

### ILLUSTRATION (2)

FIG. 2A:

Side view of built in Road Surface Generator shaft. Displaying shaft, sprockets and direction, manner and method of rotating shaft. Attached to “GENERATOR” (SEE ILLUSTRATION (1) FIG. 1G).

FIG. 2B:

Shafts located beneath road surface attached to contact pistons that are activated when vehicles traverse (pass over) road surface.

FIG. 2C:

View of sprockets attached to generator shaft.

FIG. 2D:

Contact pistons located above road surface that engage shaft and generator sprockets. This rotates the generator turbine producing clean electrical energy.

FIG. 2E:

Frontal view of built in Road Surface Generator. Demonstration of above ground piston, piston direction, manner and direction of travel of turbine.

FIG. 2G:

Side view of road surface composed of asphalt, concrete, rail or other composition.

FIG. 2H:

Side view of vehicle wheel before making contact with road or Road Surface Generator. The wheel contacts road and Road Surface Generator where the production of clean, efficient electrical current is created.

### GOAL

To harness an otherwise unused, untapped plentiful source of clean electrical current produced daily on roads, highways, bridges and all driving surfaces.

Objective:

Conversion of roads and vehicle surfaces into electrical generators by utilizing the “RSG” as an alternative energy source of electrical current production.

To provide a plentiful, abundant source of clean, non-polluting efficient electrical energy from an otherwise untapped supply sources. It utilizes roadways, highways, driveways, parking lots and any surface traversed by car, plane, train or other type of vehicle having surface contact. The “RSG” Device converts the energy produced by these vehicles into useable, clean electrical power. This electrical power will reduce the demand on electrical utilities while providing municipalities and private business and property owners with an inexpensive supply of electrical energy.

Kinetic energy is produced when vehicle drive over the device by either Mechanical (gears and shafts), Hydraulic (fluid) or Pneumatic (air) or with the assistance of Solar devices.

The Power Generating System Device converts Freeways, Roads, or other drive path surfaces utilized by all Vehicles. Drive surfaces include but are not limited or restricted to Freeways, Roads, Driveways, AirCraft runways, Train tracks, Bus Stations, Bridges and any vehicle surface. It would apply to any surface area either private or public used to transport or create vehicle movement. The types of surfaces or vehicles are not limited to or restricted to the surfaces or vehicles mentioned. Rather, it has broad international application.

Process:

The conversion would result when the vehicle comes in contact with the Mechanical, Hydraulic or Pneumatic device and the weight of the vehicle depresses the Mechanical, Hydraulic or Pneumatic activators. This action triggers the device to Mechanically, Hydraulically or Pneumatically engage gears, pistons or other mechanisms that would operate an electrical generator thereby producing clean electrical power.

Principals:

It utilizes similar principles that are inherent in the production of electrical energy by hydroelectric power plants. A hydroelectric power plant has the abundant availability of resources (water) the power and force of the water and the shear volume of water to produce electrical energy. The Road Surface Generator utilizes the abundant availability of resources (vehicles) the power and force (weight) of vehicle and the shear volume of vehicles to produce clean, efficient electrical (power) energy.

Benefits:

All types of Government (Local, National, Foreign) along with Private Business and Private Citizens would benefit from the revenues generated and the clean energy produced by the “RSG”. It produces reliable, dependable clean electrical current. Reduction of need for construction of new nuclear or fossil fueled power plants. Creation of new roads and highways with built in generator capacity. More funds that would be used to build and enhance the tax bases of local governments and improve services.

1. The Road Surface Generator invention is a unique, innovative modern day solution that relieves and solves modern day energy shortages with local, national and international applications.
